(19) United States
(12) Patent Application Publication
(10) Pub. No.: US 2002/0049625 A1
(43) Pub. Date: Apr. 25, 2002

(54) Artificial intelligence manufacturing and design

(76) Inventors: Srinivas Kilambi, Marietta, GA (US); Jaya Kilambi, Marietta, GA (US)

Correspondence Address: TECHNOPROP COLTON, L.L.C., P O BOX 567685, ATLANTA, GA, 311567685

(21) Appl. No.: 09/952,519

(22) Filed: Sep. 11, 2001

Related U.S. Application Data
(60) Provisional application No. 60/231,633, filed on Sep. 11, 2000.

(51) Int. Cl. G06F 17/60

(52) U.S. Cl. 705/9

(57) ABSTRACT

An automated artificial intelligence method and system for the design and implementation of engineering and manufacturing design services.

### BACKGROUND OF THE INVENTION

1. Technical Field

The present invention generally relates to the field of manufacturing/engineering intelligence and expert system-neural network/expert system technology for use in manufacturing and design & engineering (D&E) applications and to the field of methods and systems for providing and implementing professional solutions. The present invention more specifically relates to the field of applying sophisticated algorithms and interview technologies to allow the user to conceive and design products and processes and to the field of methods and systems for providing and implementing engineering, manufacturing, design and consulting solutions that are electronic commerce artificial intelligence-based, neural network-based, expert system based and vertically integrated from concept to completion.

2. Prior Art

There are many problems with current methodologies in manufacturing intelligence. Manufacturing intelligence (MI) is too diffused across an enterprise within an organization. Often, corporations lack the information on the whereabouts of their own experts. This could lead to significant delays in intelligent information transfer during crisis. Additionally, MI from experts often is incomprehensible due to communication and knowledge gap problems leading to severe process down times and production failures. Further, MI often lacks compatibility. Most solutions emanating from process experts in research and development (R&D), design engineering, and operations lack continuum and compatibility due to a synchronization of knowledge. For example, two experts often come up with three or more solutions, leading to a greater problem.

There also is no concept to completion (C2C) distribution of solutions. There is no process that links and distributes MI from R&D to design engineering and then to process operations. This gap leads to improper process manufacturing, and costly and/or lengthy solution implementations. Another problem is that MI is people dependent. No process currently captures and stores MI. MI is lost when people leave the enterprise. Also, most modeling and simulation software tells an engineer how to model but does not empower an engineer with the intelligence to outline what processes are required in which sequence, when and why.

An overarching problem with current MI art is that most MI software cannot be customized to fit in a particular customer's organization. Current MI products have stock intellectual property treatments, and common or averaged information and intelligence. Additionally, currently to perform MI, one must use several off-the-shelf and customized software applications and/or perform significant hand calculations in process design engineering resulting in a complex, time and cost consuming process. As a result, customer expectations are rarely met due to minimal customer choice and interaction. Most of these problems are caused by the current belief that most manufacturing solutions are based on the process control principle that one problem has one cause and that there is one remedy. This is rarely the case.

On the design engineering side, current methods and systems for providing and implementing engineering, manufacturing and consulting solutions entail an array of steps and lack a unitary solution. For example, a user seeking such solutions must create scope documents, select an implementation partner to modify the scope documents and produce basic engineering documents that outline the process schematic, cost, and the manufacturing process. Detailed engineering documents that include details such as manufacturing process, equipment specifications, suppliers, cost, project timeframe, and budget are created from the basic engineering documents, which, after approval, are use to secure quotes from vendors and experts for the project. After this, a list of potentials vendors and experts is created and formal purchase orders are issued. Finally, the project is implemented and brought on line. This entire process usually takes several months and costs the user between 8-10% of the project budget, which can be substantial depending on the nature of the project.

The lack of a continuum throughout the steps of the current methodologies has lead to unnecessary costs and inefficiencies. First, the lack of a single source or continuum between the resources necessary to implement solutions (such as R&D, D&E, and Operations), time resources must be expended assembling the resources, which adds costs and delays. Second, there often is a lack of communication and/or miscommunication between the many parties involved. Third, if persons active within the user leave (thus further disrupting the continuum), the knowledge associated with the person is lost because such knowledge is not captured in single location for easy accessibility by others and leads to duplicative efforts to operational problems and design projects.

As can be seen, these deficiencies of the prior art have generated a need for a novel and efficient method and system for manufacturing intelligence and expert system technology for use in manufacturing and design applications and for providing and implementing professional solutions. There is a need for a closed loop method that can design, upgrade or otherwise create products and processes, detect problems and automatically implement the derived remedies. Therefore, it can be seen that there is a need for a C2C based vertical unitary solution that can be administered on a network for assisting and providing manufacturing or design engineering businesses with solutions and consultation services on projects. The present invention is directed to this end.

### BRIEF SUMMARY OF THE INVENTION

A goal of the present invention is to unify and synchronize manufacturing intelligence (MI), and provide an intelligence continuum across an enterprise through the introduction of Internet/Intranet enabled Artificial Intelligence Manufacturing (AIM). AIM serves the process manufacturing industries worldwide by unifying and capturing MI, by providing a standard MI continuum across an enterprise, and by empowering the engineers/operators with the ability to determine what processes are required in which sequence and when and why. AIM enables conception, production, and delivery of expert/intelligence information from any user and reduces the dependency on the availability or experts. AIM simplifies and economizes critical business processes by enabling manufacturing companies to start, expand, maintain, or operate their worldwide facilities over the Internet or an intranet by implementing an expert system neural network/expert system based on artificial intelligence

The present invention is a method and system for providing and implementing professional solutions, such as methods and systems for providing and implementing engineering, manufacturing, design, and consulting solutions that preferably are electronic commerce-based, network-based, and vertically integrated from concept to completion. Briefly, the present invention uses past (previously entered) and current (entered for a specific project) information (including expert knowledge); receiving the parameters for a project from a user, and providing a solution to the project based on the user's inputs, secondary inputs, the past and/or current information. This is all made possible by a combination of expert systems, rules, algorithms, models, data and trainable neural network/expert system comprising analysis rules implemented automatically or with the aid of human experts.

The present invention enables businesses, entrepreneurs, maintenance engineers, design engineers, and consulting firms to obtain economical, efficient, and state-of-the art technology-based design engineering solutions, to access the resources needed to implement the solution, and to provide on line quality assurance, quality control and trouble shooting tools for a continuous operation. The present invention further provides solutions to engineering, manufacturing, design, and consulting projects using a combination of expert systems, rules, algorithms, models, data and trainable neural network /expert system neural network/expert system that comprises analysis rules that can include logical rules, mathematical rules, mathematical equations and algorithms, subroutines and rules, and meta-rules (rules derived from rules and solutions).

The present invention can be used by industries including but not limited to pharmaceuticals companies, chemical industries, refineries and oil and gas industries, pulp and paper industries, beverage industries, food processing industries, mining industries, architecture and engineering firms, environmental industries, and electroplating industries. It is contemplated that the method and system can generate a solution that can be certified and accredited by engineering firms, professional associations, business institutions, chambers of commerce.

One feature of the present invention is that it reduces the diffusivity and asynchronization of MI across an enterprise resulting in faster C2C implementations.

Another feature of the present invention is that if allows for a standard MI quotient by allowing the conversion of all manufacturing personnel into experts for enhanced yield and efficiency and lower down times. This also allows instant process trouble-shooting and optimization.

Still another feature of the present invention is that it is expert independent. MI is now captured for enterprise-wide use. This reduces the loss of MI when human experts leave an enterprise or are unavailable.

Yet another feature of the present invention is that its use of artificial intelligence empowers a user by selecting the desired unit processes (what), arranging the processes in the right sequence (which), by using logic to select, add or discard processes based on customer inputs (when and why).

Another feature of the present invention is that it is customizable to a particular enterprise. For example, the analytical rules are customizable to cater to individual customer designs or knowledge.

Still another feature of the present invention is that it is faster and more economical that the current art. Rather than using many different software applications, hand or computer number crunching by humans, and spreading various tasks throughout an engineering or design division of an enterprise, the present invention provides a unitary method for providing solutions to engineering, manufacturing, design, and consulting projects.

A further feature of the present invention is that it is customer driven. The present invention offers complete user choice and interaction through a user driven solution. This allows the user to select between using a stock or canned solution based on prior input of information and rules or using a proprietary solution based on the user's own current input of information and rules.

Yet another feature of the present invention is its functionality. The present invention operates on the non-linear principle that one problem may have many causes and, therefore, many remedies.

These features are brought together in a seamless integration using an Internet- or intranet-enabled solution that integrates manufacturing, design, engineering, procurement, construction, and operations.

These features, and other features and advantages of the present invention, will become more apparent to those of ordinary skill in the relevant art when the following detailed description of the preferred embodiments is read in conjunction with the appended drawings and appendices.

### BRIEF DESCRIPTION OF THE DRAWINGS

FIG. 1 is a conceptualized sequence chart of one preferred embodiment of the present invention.

FIG. 2 is a general flowchart of a representative software application carrying out the present invention.

FIG. 3 is a general flowchart of representative levels of solutions that can be used in the present invention.

### DETAILED DESCRIPTION OF THE PREFERRED EMBODIMENTS

1. General Background Of The Preferred Embodiments

The manufacturing and design environment mandates the need for quick solutions to complex problems, which have to be accurate, cost and time effective. For example, chemical and process manufacturing involves numerous mathematical algorithms, complex process design engineering and operations design engineering (PDE/ODE) models, significant research and development (R&D), extensive pilot testing and simulations, and a variety of process control systems and instrumentation. The present invention vertically integrates or combines these existing control systems, algorithms, models, simulations and the like into a unified scaleable, and automated method. Generally, the present invention is the application of artificial intelligence to the engineering field by applying expert systems and neural net solutions to the manufacturing and engineering design processes. The use of software and equations in engineering design is known and old in the art. However, the use of artificial intelligence to automate, enhance, economize, and expedite the design process is not known in the art.

The present invention provides (1) a method for answering what if questions arising from scenario planning; (2) designs and solutions ranging from as large as erecting a whole manufacturing plant to as small as designing equipment for a small process; (3) the knowledge as to what operations should be carried out, why, when and in which order, including operation simulation, modeling, optimization and troubleshooting; (4) various kinds of expert and complete end-to-end solutions for a myriad of process such as for example water treatment, waste water treatment, air pollution control, oil/water separation designs and any metal recovery using supported liquid membrane; and (5) expert and accurate solutions using combinations of numerous algorithms, simulation and optimizing techniques, and mathematical models thus reducing the time as well as costs.

The basis premises behind the present invention comprise the use of expert systems and neural networks to assimilate information and rules, apply this information and rules to input parameters, and to provide a solution based on the application of the information and rules to the input parameters. Termed by the inventors Artificial Intelligence Manufacturing (AIM), the present invention allows the user to obtain a solution based on a clean slate (the user inputs all of the rules and parameters), based on a stock or canned methodology (the user selects from a variety of stock or canned rules and inputs new parameters), or a combination of the two (the user selects from a variety of stock or canned rules and modifies these rules or inputs additional or substitute rules, and inputs new parameters). AIM then uses the input parameters to arrive at a solution based on the inputted or selected rules. The inputted rules and parameters, as well as the solutions, are added to a repository for later use by the user or other users, thus increasing the knowledge base of the invention.

For the purposes of this invention, the term rules refers to and comprises the universe of known equations, graphs, charts, and tables used to design products and processes as well as proprietary equations, graphs, charts, and tables developed by users to design proprietary products and processes. For the purposes of this invention, the term information refers to and comprises the universe of standard parameters and properties of known products, processes, materials, compounds, elements, and the like, as well as proprietary parameters and properties of proprietary products, processes, materials, compounds, and the like. For the purposes of this invention, the term parameters refers to and comprises the specific parameters such as temperature, pressure, mass, flow, composition, state, and the like used to design the desired product or process.

The present invention is a dynamic process model for providing expert solutions to the process manufacturing industries that can be customized to suit any organization. The preferred embodiments include the computer execution of the steps proceeding through a graphical user interface (GUI) for data entry and data retrieval and including steps from the following assemblage: (1) selecting a level of service (basic design through complete design); (2) inputting the type and parameters of the project; and (3) receiving an automated solution based on a trainable neural network, past inputs of information and rules, current user inputs of information and rules, and secondary inputs of information and rules. If the user desires, procuring the equipment services designed for the project, including selecting and ordering instrumentation and controls, procuring construction services for the project, procuring installation cost quotes and selecting and contracting with an installation firm at this step, procuring as necessary or desired additional expert services for operating and maintaining the designed process, and tracking the design, development, construction, and operation through the system.

Embodiments of the present invention can be administered from a website or hardware that can contemplate computer-executable instructions that enables the formation and operation of an enterprise. The method and system of the present invention can supplement and/or replace the current cumbersome manufacturing and engineering design software packages with a cost savings. The result is an embodiment comprising e-consulting, e-supply chain management, and e-project management that is applicable globally via the World Wide Web or other network portals for maximizing economic efficiency and allowing users to check the status of their projects globally.

The invention can retain in memory all of the aspects of the design for later referral. Importantly, the invention retains the costs for the project and allows the user to track costs and the progress of the design. For example, all of the design, procurement, construction and operation of the project is tracked by the invention, allowing the user to have a one-stop location for a complete engineering solution. If costs change, or construction strays from a schedule, the user can choose, online, alternative vendors to put the project back on track.

The preferred embodiment utilizes a network-based site that users would access for their design and engineering needs. The site has a question and answer session. The user then can choose to obtain the process schematic, plant and equipment design, flow characteristics, mass and heat balances, and other necessary engineering and construction solutions by initiating the question and answer session. Moreover, the user can ask questions of consulting or design engineering experts that cannot be answered by the automated web site.

2. General Methodology Of The Preferred Embodiments

During a typical user interaction, the user is asked a number of questions. The answer to these questions may be data from a drop-down list, or text, numbers or equations that the user provides. One example of the questions that may be asked of the user is show in the sequence of screen shots shown in Appendix A, which provides for entering specific parameters and using stock or canned rules to arrive at a solution. Using the blank slate scenario, the user would be prompted to enter their own rules (equations and/or data), which then would be applied to the inputted parameters to arrive at a solution. The inputted rules and parameters and the arrived at solutions can be stored in an electronic repository for later use (either by the same user or now as part of the stock or canned rules and solutions scenario), thus adding to the AIM universe of solutions. This, in short, is the general premise of the invention.

The software architecture of the invention preferably is structured to enhance the extensibility of the invention. That is, the software preferably has the ability to add questions for data entry, as well as rules on the fly. The knowledge base of the invention can be deterministic and/or probabilistic (best-fit), so that the user can choose from multiple possibilities. Likewise, the software preferably comprises standard forward and backward chaining functions. Using the stock or canned rules and/or the learned rules (that is, the new or proprietary rules inputted by the user), the invention preferably has the ability to make specific recommendations and to query the user for necessary and/or additional input, and to allow the user to query and understand why the recommendation was made.

Many of the rules initially can be entered into the repository by experts, creating an initial knowledge base. For example, an expert can interactively teach the system specific capabilities. Basic unit operations can be entered (such as equations and data from chemical engineering handbooks), basic properties can be entered (such as from the Merck® index), and basic designs can be entered (such as from process engineering handbooks) to provide this initial knowledge base. This basic initial knowledge base can be the foundation of the stock or canned scenario and also can serve as the springboard for rule guessing, or the ability to use rules with applicability levels, thus mimicking the guessing of relationships. As the invention is used, the inputted rules and parameter, as well as the arrived at solutions, are stored in the repository, thus increasing the knowledge base.

The software for the invention can be utilized over the Internet or over an intranet. If used over the Internet, there are two methods of use that can be implemented separately or in combination. The first Internet method comprises utilizing the method to arrive at solutions based on a general knowledge base comprising rules, information and solutions previously entered by and created for the universe of users. This method utilizes the invention as a general design source. The second Internet method comprises utilizing the method to arrive at solutions based on a specific knowledge base comprising rules, information and solutions previously entered by and created for the specific user or the specific user's company. This method utilizes the invention as a private design source stored on a remote server computer. The intranet method comprises installing the software on the specific companies computer network and allowing the specific company's experts to populate the repository with the specific company's rules, information and solutions. This method utilizes the invention as a private design source stored on a private computer network.

The actual software used to power the invention is a matter of choice. Although the inventors developed proprietary software for one embodiment of the invention, a programmer of ordinary skill in the art could write suitable code to carry out the invention. Generally, for the stock or canned scenario, the software must allow the user to input specific information and parameters and access general rules and information, and must apply the rules and information to the input to arrive at a solution. For the blank slate scenario, the software must allow the user to input specific information, parameters and rules, and must apply the rules and information to the parameters. For the combination scenario, the software must allow the user to input specific information, parameters and rules and to access general rules and information, and must apply the rules and information to the parameters.

The software preferably further comprises artificial intelligence features allowing the software incorporate new inputs, parameters, rules, equations, and solutions into the knowledge base. The ability for the software to make suggestions based on previously inputted and newly learned information also is desirable. There currently is commercially available artificial intelligence software to conduct these basic steps, but his software has not been applied to the engineering and design and process manufacturing fields.

3. Representative Implementation Of The Preferred Embodiments

In a typical implementation of the present invention, experts (preferably from the end user client and implementation partners) gather, sort, synchronize and assimilate MI. This MI is entered into the knowledge base repository of the invention through a GUI. Information submitted through this GUI populates special database tables. The MI is compiled and deployed over a network, such as the Intranet or an internal company intranet. The compiled information preferably is tested, modified, and validated by the experts for enterprise-wide use. The MI now can be used by all R&D, D&E, and operations personnel for instant optimization, troubleshooting, and design engineering.

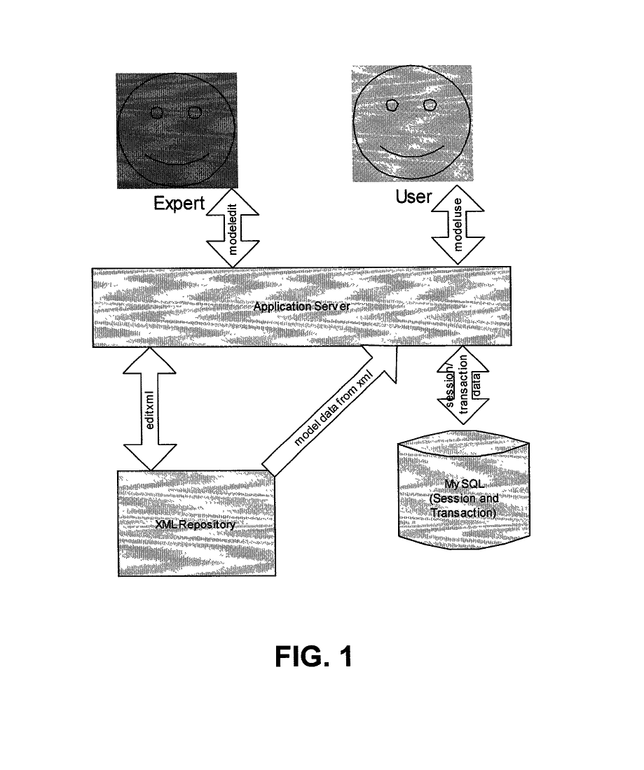

Referring to FIG. 1, one preferred embodiment of the present method comprises the basic components of one or more experts 12, one or more users 14, a knowledge base repository 16, and a session and transaction database 18, all interconnected by an application server 20. The knowledge base repository 16 can be a blank slate, but preferably is populated to at least a minimum degree by the expert 12. Specifically, the expert 12 interacts with the knowledge base repository 16 through a set of pages dynamically generated from the software, and enters the desired minimum information. This information can include, but is not limited to, general and specific query language prompting users to enter information, parameters and/or rules; general and specific equations for designing various products and processes; charts and tables comprising data for materials, components, and compounds; solid and fluid flow information and tables; and the like. Likewise, the knowledge base repository 16 can include prior solutions, parameters, known or stock solutions, and expert knowledge for an engineering, manufacturing or consulting project. The knowledge base repository 16 provides the basis for future solutions and provides a means to store information and future solutions for the convenience of the user 14.

In somewhat more detail, the relevant knowledge can be incorporated into the knowledge base repository through an array of manners. The knowledge can be developed by one of ordinary skill in the art using information from the user's experts, consulting experts, information synchronizing experts, and other experts. Experts from the user's fields and experts from other areas can gather data on past solutions and enter them into as knowledge for use in the present method. Alternatively, the knowledge can be an importation of relevant information from corporate records or from other database programs. Alternatively, the user 14 could start without any knowledge and add knowledge to the knowledge base repository 16 as it arises in the course of business. Additionally, it is contemplated that the knowledge for the knowledge base repository can be developed by independent entities for sale to the entities administering the present invention. Such independent experts can use a staff of experts and references to create a knowledge base repository 16 of solutions and information relevant to the field in which the present invention is applied.

The knowledge base repository 16 and other elements of the preferred embodiment can be accessed through a GUI that is part of the application server 20. In response to inputs by the user 14 via a user interface such as a computer keyboard or other conventional user interface, the user 14 can proceed through the a series of options to develop and/or to implement a solution to the user's project. Appendix A contains screen shots of an example GUI and can be referenced during the following discussion.

At the GUI of one preferred embodiment, the user 14 can be prompted with a common login mechanism. The login mechanism can provide a means of tracking the activity of the user 14 and of documenting future solutions. Further, the login mechanism also helps ensure that only selected persons access the knowledge base repository 16 and aids in maintaining trade secret protection of data in the knowledge base repository 16 by keep unauthorized users out. A first time user 14 can be requested to submit data that can be used to identify the user 14. One further advantage of a login mechanism is that it can ensure that the user 14 understands the costs and details of obtaining a solution through the invention before deciding to use it. This feature is particularly important if the present method is administered by third parties. The system administrator can place contractual offers on the site that can be accepted with the successful entrance of the login information.

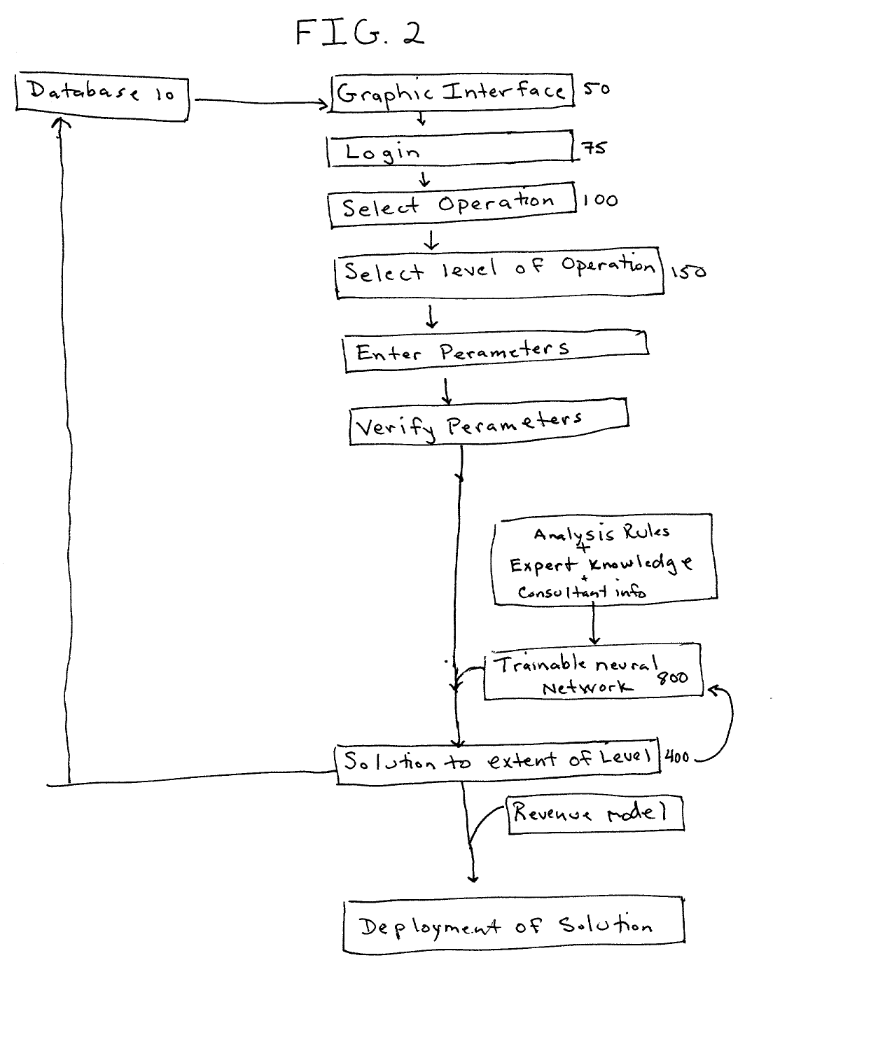

FIG. 2 illustrates a general flowchart of a preferred embodiment of the invention. Once the user 14 has logged on, if required, the user 14 can be prompted through a series of steps comprising selecting an operation (such as for example obtaining a stock or canned solution or obtaining a proprietary or specific solution), selecting a level of solution (such as for example from a lowend general solution to a high-end specific solution reviewed by experts and/or professional engineers off line), and entering the required information (such as for example input parameters, information and rules). The invention then writes this input to the knowledge base repository 16, applies the relevant input to the relevant rules, and arrives at a solution.

The knowledge base repository 16 can be populated with various stock solutions, as discussed in the examples below. In this manner, the invention can be used as the first line in developing relatively common products and processes in an expedited, efficient manner. The knowledge base repository 16 also can be populated with industry specific solutions.

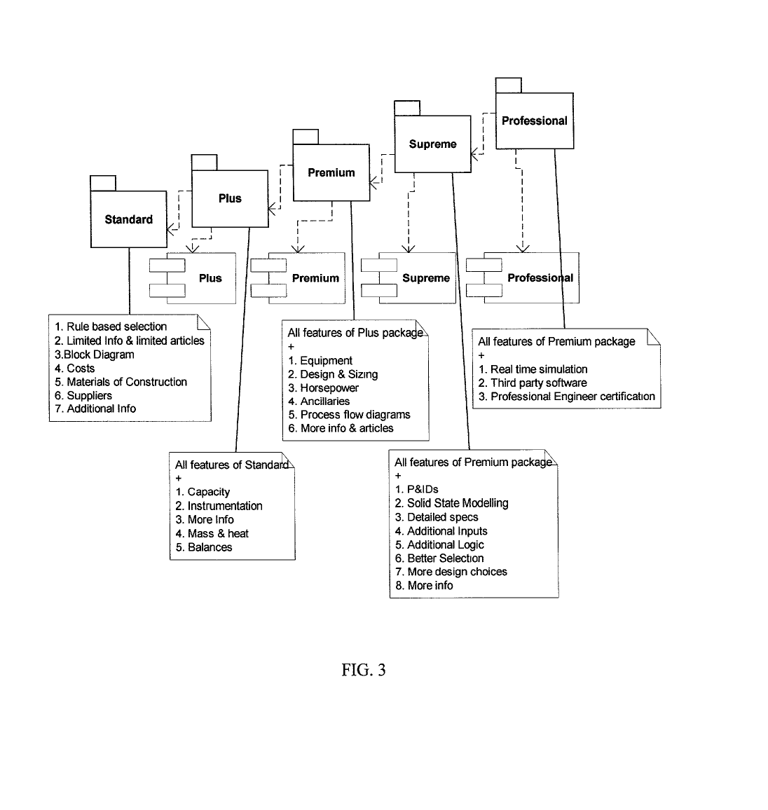

Referring now to FIG. 3, representative levels of solutions for designing processes using the present invention are shown. The level of solutions can range from basic low-level designs (standard) to complex high-level designs approved by professional engineers (professional). Although the designations and levels of solutions can vary, the exemplary levels, as shown in FIG. 3, are standard, plus, premium, supreme and professional 190. Each alternative level of service can require the entry of a discrete set of parameters and provides a discrete level of solution. It is contemplated that this aspect of this embodiment can be set-up in a manner that can allow the user the choice of more and less levels of solutions. It also is contemplated also that the present invention can provide an array of levels that differ in accuracy, detail, and/or certification.

The standard level of solution can be used to provide preliminary solutions, which are intended to provide the user with a basic idea of a solution and a basis to decide whether to select a more advanced level of design development or seek an alternative source. The plus level of solution can be used to provide a low-cost solution with accuracy greater than the standard level. The premium level of solution can provide a medium cost immediate on-line solution, which for example can have an accuracy of around 90%. The supreme level of solution can provide added design detail. The professional level of solution can be equal to the level of those services obtained from professional consulting firms and can be professional, complete solutions that are certificated, vetted, and approved by licensed engineers or other professionals. Specifically, the solutions can be reviewed by professional engineers in alternate locations and can be used to create a near perfect solution. This fourth level of solution can include the supervised implementation of the solution by the method provider.

An advantage of the professional level is that it can allow for greater resource efficiency by utilizing resources, such as but not limited to vendors, consultants, and experts, from other areas of the country or the world. For example, greater cost and profit margins can result if part or the entire product or process were developed in a non-US country at a fraction of comparable US costs if there is a favorable currency exchange rate or if labor costs are less in the non-US country. Furthermore, users can exploit the invention in a geographical area where there are no local consultants working or where there is a lack of the necessary technical skill and obtain competent design engineering and consulting. More importantly, resources can be obtained from across the world thus lowering productions costs and maximizing efficiency. The mix of distribution channels will give the advantages of faster, cheaper, and more effective communication over prior methods of design engineering and consulting. Additionally, the system allows the user to utilize resources that may not be in the one area.

After the user 14 is promoted to select a level of service, the user 14 is prompted with one or more input screens. An input screen can prompt the user to input the parameters of the specific components or desired characteristics in the end solution, the rules desired or the new or proprietary rules to be used, and any other information necessary to arrive at an appropriate solution. The input screen can be dependent on the specific field in which the present invention is employed and one of ordinary skill in the art will be able to select construction input prompts for a field without undue experimentation.

The input then is deposited in the knowledge base repository 16 where it can be available for future use and for training the invention through the expert systems and neural network/expert system to implement new solutions or prompt additional questions. Expert systems and neural networks are features of artificial intelligence that apply rules and analyze data. For example, a typical artificial intelligence inference engine arrives at a solution based upon the answers to queries, analysis rules and/or the knowledge base repository 16 information.

Based on the field of use, the user or implementer may need to select analysis rules to analyze the projects. The term analysis rules as used herein include at least mathematical rules, scientific rules, probability rules, rules of manipulation, rules unique to the field of implementation, rules for integrating rules to form new rules, and rules from trials. The queries and subject matter expertise define one aspect of the analysis rules for training the neural network. The automated solution is obtained based on the database and the neural network/expert system or rules that are dependent on the field of use and will be obvious to the person of ordinary skill in the art.

The analysis rules for engineering, manufacturing, and consulting services are well within the skill of those in the art. For example, a graduate chemical engineer can design most unit operations and the equipment to carry out the unit operations and a graduate mechanical engineer can design most mechanical aspects needed by a user of the invention. Further there are various commercial computer programs that can automatically design and specify processes and units upon the input of the process or unit parameters. Alternatively, the service provider can develop, without undue experimentation, proprietary or custom software or processes for designing and developing processes and units. Whether using a commercial software program, an actual person, or a custom software application, one of skill in the art can create the links between the front end of the invention (such as the GUI and screens through which the user maneuvers) and the back end of the invention (the actual persons and/or software that designs the processes and units). Likewise, professional engineers are available, either as private individuals, as company employees, or as staff members of the service provider, to review and sign off on the design specifications.

The trainable neural network/expert system is trained using the data stream (resultant) generated by queries received from local and remote users. The trainable neural network/expert system essentially is trained to follow analysis rules, to develop new analysis rules, and to discover patterns perceivable by persons in the fields of engineering manufacturing, design, and consulting services. The neural network/expert system is further trained using the data stream or results generated by the method. The sequential and logical reasoning offered by the inference engine, and the self-organizing, learning, response, and abstraction offered by the neural network/expert system when implemented on voluminous corporate database contained in the multitude of database servers, combined with universal access through questionnaire and information inputs, provides the user with solutions to problems. Data or predictions from the trainable neural network/expert system could also feed the expert system for unsupervised learning and for higher accuracy.

Once solutions are acceptable to a user 14, the system establishes the solution as basis for a new rule and stores the solution in the knowledge base repository 16 for future use. Thus, the method includes a step to provide solutions that are not pre-programmed in the knowledge base repository 16, and provides the user 16 with intelligent solutions based on prior data and user information. The construction of a computer-based trainable neural network/expert system is known to the person of ordinary skill in the art. Based on the neural network, the knowledge base repository 16, and the user's inputs, the preferred embodiment can present the user with a solution to the user's project.

If the user 14 has any further questions or concerns about the solution specified by the invention, the user 14 can contact a design engineer or other professional through an optional addition to the invention. One advantage of the present invention is that it can work with the consulting firms in arriving at a solution. Various icons can be accessed leading to specialists (for example, links to the specialists' websites) or question forms can be accessed allowing the user 14 to submit questions to be answered at some time in the future. For a second party service model, all icons and question forms could lead to the second party service provider, who would have the expertise in-house (or would have the ability to obtain the expertise) and would respond to the queries. For an in-house service model, the icons and question forms could contact various people in the user's own organization for answers. In both service models, the icons and question forms could lead to third party experts, professionals, and companies.

4. Examples

The following examples illustrate methods or products of methods of the present invention. The examples are intended to show how that the invention is versatile and can be employed in an array of fields. In such examples, the person of ordinary skill in the art can employ the present invention and produce an embodiment that can produce the described exemplary products without undue experimentation. The examples are intended to further illustrate that the present invention can be can be customized for the appropriate design, piece of equipment or process according to accepted engineering and manufacturing design specifications. The following examples are not intended to limit the scope and/or spirit of the present invention.

### Example 1-Products

This example is intended to show that the present invention can be used to design new products based on the properties of known products. This exemplary process can use an iterative method to arrive at a model for a new product.

If a company has 20 current products and it decides to develop a new product based on the properties of the 20 current products, but does not know the properties of the resulting 21^{st} product, the expert team can start an iteration procedure to determine the properties of the 21^{st} product based on the known properties of the 20 current products. The user enters the rules, such as the 21^{st} product will comprise 5% (by weight or volume) of each of the 20 current products. The properties of the 20 current products are entered, and the invention uses the rules to assemble all algorithms, models, rules, equations, and data of all 20 current products with a 5% weighted average into a new model for the 21^{st} product. The results are properties for the 21^{st} product based on the properties of the 20 current products.

The user can do concept to completion simulations on the new 21^{st} product based on the arrived at properties, and can perform R&D lab tests to confirm the simulation results. If the results do not match, the user can change the model as desired. For example, the 21^{st} product can be based on the 10% weighted average of each of current products 1-5 and 10-15. The invention then uses this updated rule set to arrive at the properties for the updated 21^{st} product.

These steps can be repeated and the resulting 21^{st} product can be reassessed until a >90% match (or whatever confidence match is required) between the experimental results and the simulation results from the model are obtained. Once experimental results match the simulation results to the desired degree of confidence, the final model can be used to conceive, develop, engineer, and optimize the 21^{st} product.

This will reduce uncertainty, product introduction time, R&D trials, failure, etcetera, as the user now has a model that closely approximates the new 21^{st} product properties, which the user did not have before.

### Example 2-Processes

These examples are intended to show that the present invention can reduce inefficiencies in fields, such as electroplating, and that the present invention is distinct from the prior methods for design engineers and manufacturing consultants.

Chemical and process plants are operated and controlled by a variety of control systems that are normally programmed on the basis of certain process parameters. In spite of the control systems, there are numerous scenarios where they are not effective in averting a production loss or an accident. The present invention combines existing control system algorithms along with other scenarios from various knowledge bases, such as hazardous operations (HAZOP), HAZAN, fault-tree analysis and the knowledge base of the operations and design personnel, on a single platform. Although the present invention does not eliminate the need of the operations and design personnel; it increases their productivity, efficiency, and efficacy by allowing for instant process troubleshooting, optimization, real time simulation and modeling.

Prior to the present invention, entities have relied on design engineers and manufacturing consultants to solve problems in electroplating without respect to prior solutions. On occasion, a consultant may have come across a design from a prior occasion, but this is the not the norm given the array of projects. Because there is not a repository of the electroplating industry's production problems and their probable causes and remedies, when a new problem in electroplating that was similar to a prior problem occurs and is rectified, the engineer must start from the beginning when trying to solve the problem. Thus, this lack of a repository leads to inefficiency, delays, and expenses for duplicative services.

The present invention can reduce the inefficiencies and duplicative problem solving. One application of the invention could be customized to suit specific industry needs and when data analysis rules are added to the embodiment, it can solve future problems based on the prior solutions in the database. Aspects of the invention could interface with detection equipment, controller software, hardware making, which could then suggest solutions when it detects problems. These combined capabilities would provide reduced project costs, project time, enhanced productivity.

Additionally, when the engineer solves the problem initially, or when the problem is not in the database, the engineer adds the information into the knowledge base repository 16 for future reference. Thus, if and when the problem occurs a subsequent time, it can be solved based on the prior information and analysis by elements of the present invention as embodied in the neural network.

Let us assume that a company needs to build either a new wastewater treatment plant or needs to expand/upgrade/retrofit an existing plant. The company could use the stock or canned rules of the invention to prepare a technical scope document instantly using the standard level of solution. This scope document would contain all the influent and effluent parameters, list of processes and equipment selected, instrumentation, mass and heat balances and a process flow diagram. This scope document could then be used to create an RFP for soliciting design, engineering and EPC bids. All that would be required for this implementation is an initial input of common unit operations, process design, and equipment design equations, and materials data into the knowledge base repository 16.

An engineering consulting firm could use the plus and premium levels, containing previously inputted P&IDs and detailed equipment specifications, to respond to RFPs in minutes thereby reducing thousands of engineering man hours. The supreme level could also be used for the construction of small wastewater treatment plants and the installation of medium wastewater treatment facilities and to model, optimize or simulate most unit processes online. The professional level could be used for large plant installation and customization. The invention in this example is essentially a single window system, integrating all services, reducing project costs, lead-time and hence reducing the time-factor-of-money.

### Example 3-Process Manufacturing

This example is intended to show that the present invention can be used to assist persons in an industry not entirely familiar with the process and can be applied in a manner that can allow persons less familiar with the project to solve problems and develop solutions.

A combustion furnace fired by a gaseous fuel, which is atomized by primary compressed air and secondary air, is common in many industries. If problems with the furnace occur, e.g. the temperature within the furnace is dropping, the furnace operators may not be experienced enough to circumvent problems. Normally, the operator would be forced to contact a design engineer or a more experienced person in the facility to get an answer, which wastes time and resources. Alternatively, the operator may attempt to solve the problem independently by increasing the fuel, air, etc to boost the temperature. However, the problem may be somewhere else, and this could lead to a runaway reaction/process, and cause a catastrophe, or at least damage.

An embodiment of the present invention allows the operator to attempt to adjust the device. If a design engineer already has encountered the problem, the solution should be in the knowledge base repository 16 and the operator can easily access it by the question and answer session. An implementation of the present invention initially would advise the operator to consider the flow rates of fuel, air, etc., check them for accuracy, and if found correct, prompt the operator to check other possible causes. Specifically, the operator would enter the parameters of the system into the invention, and the invention would apply the previously developed rules and arrive at a solution. The problem could be a faulty thermocouple/ temperature sensor, a refractory failure blocking the temperature sensor or thermowell, a defective temperature transmitter/indicator or the connecting cable.

In addition to the allowing the operator to solve problems that occur within a given unit, the present invention allows instant real time simulation, modeling, and optimization of all parameters for best performance. If the operator keeps a detailed record, a design engineer can review the operator's activities and determine whether these perimeters should be entered into the database for other in the company to use. Thus, the present invention can also facilitate the operator in day-to-day operations, troubleshooting and answering all problems normally encountered.

### Example 4-Troubleshooting

One important advantage of the present invention is that it is capable of detecting operational and production problems, sorting all possible causes, and suggesting and implementing remedial solutions in a manner that is captured and shared easily with others. In case of process failures or emergencies, the invention can enable an operator, who may not be a familiar with the process, to quickly respond and implement remedies that have been captured on the database. This would significantly reduce operational downtime and increase productivity and yield. These solutions would result in a significant reduction in labor and overhead (consulting) costs and in a reduction of duplicative costs. More importantly, the information captured in the event the person who solved a prior problem is unavailable when a similar problem arises in the future. This also would enable one operator to operate more than one process line/shift thereby saving costs.

Specifically, if a particular process or unit is not operating properly, the user can access the invention, input all of the process or unit's design parameters, and have the invention redesign the process or unit. If the redesigned process or unit is identical to the process or unit in use, the user can be fairly certain that there is an equipment malfunction, or one of the operating parameters is out of specification, and may be able to make a quick and inexpensive fix. If the redesigned process or unit is not identical to the process or unit in use, the user can be fairly certain that a new process or unit needs to be installed, or that the process or unit in use must be altered (or the process or unit inputs and outputs must be altered).

### Example 5-Building a New, Expanding, or Retrofitting a Plant

This example is intended to illustrate that the present invention can be used to build, upgrade, expand, or retrofit existing plants.

Based on prior buildings specifications and or other matter in the programmed database, the user can use the invention to prepare a technical scope document. The scope document can contain all the influent and effluent parameters, a list of processes and equipment selected, instrumentation, mass and heat balances and a process flow diagram. This scope document then could be used to create an RFP for soliciting design, engineering, and EPC bids.

The present invention provides the user with the resources to implement or convert the scope document into an operational plant, and can provide the option of choosing between different equipment and different suppliers. It can facilitate in identifying all consultants, contractors, and suppliers required for the project, making supply-chain management easy.

In this example, the user 14 can opt to obtain on-line quotations from vendors and place orders for plant equipment, civil construction, erection, and commissioning. The method can be customized further by allowing the user 14 to register his or her own vendors. The present invention also can incorporate services including but not limited to marketing, advertising, personnel, custom brokers, freight forwarding, shipping, tracking, incorporation or legal assistance, engineering services, commission services, trade services, business plan services, bank or venture capital financing and other miscellaneous services to businesses. All of these services can be provided by the service provider or through links to third party vendors. It is known by the person of ordinary skill in the art that other services and products can be included in the present invention to aid and support design engineering and manufacturing design without departing from the invention.

The preferred embodiments can assist the user 14 in obtaining engineering or manufacturing design solutions for a new facility or for the expansion, operation, and maintenance of facility, or to obtain a design specification based on the parameters previously inputted by the user 14 and on prior solutions in the knowledge base repository 16. The user 14 can select whether to create a design specification for the process and/or the process unit. The design specification contains all of the specifications needed to build or procure the process or process unit. Further, the invention can be configured to provide other useful information to the user 14, such as a recommended type or quantity of unit and other necessary or suggested steps or units to optimize the process. A sample design specification and sample information pages are given in Appendix B.

Once a user 14 has accessed all of the design and development features desired, the user 14 can access an optional national and international market solution module (e-market). The e-market route enables and facilitates trade, import/export, purchase, and sale of goods and services. The present invention also can provide links to the financial resources necessary to fund the user's 14 project. The e-market can enable a user 14 to open a letter of credit, obtain working capital from banks, and download performance invoices, bill of lading, and other documentation. In short, after the user 14 has used the invention to design and implement the process or unit, the user 14 can access a series of additional and optional products and services to market and distribute the products produced by the process or unit. Additionally and optionally, the user 14 also can buy or sell featured products or track shipments/products through the present invention. The user 14 also can use on-line order forms for sale/purchases and use an online tracking system for order status update, and fulfillment.

Once the design specification has been developed by the invention, the user 14 can be presented with a procurement page, where the user 14 can review and procure the equipment designed for the project. The service provider can provide the equipment to the user 14, can procure the equipment for the user 14, or can provide access to various vendors for the equipment, along with the instrumentation and controls necessary for the equipment. The user 14 can select and order the equipment at this step, or can just obtain price quotes. Alternatively, if the service provider allows third party vendors to be contacted by the user 14 through the invention, the service provider can collect a commission from the vendor and/or charge a subscription fee for allowing the vendor to be listed on the procurement page.

The invention can utilize outside material providers when they have the resources necessary to expedite the development product. The providers are selected based upon their expertise, active participation, reputation, and success in their field, plus overall quality of their materials. When beneficial, it is preferable to blend the offerings of several providers to create an optimum hybrid product yielding the most benefits to the user 14. Thus, the user 14 can be presented with a variety of vendors at a source, creating a marketplace of vendors. This can allow the user 14 to obtain the best component or service at the best price for the designed process or unit.

Once the equipment, instrumentation and controls are selected and ordered, the user 14 can be presented with a construction page, where the user 14 can contract for the construction of the project. For example, the user 14 can select and contract with a construction firm at this step, such as the necessary chemical, mechanical, and civil engineering firms necessary for plant construction. The service provider either can construct the process or unit for the user 14, can procure the construction contractor for the user 14, or can provide access to various construction companies. The user 14 can select and contract with a construction contractor at this step, or can just obtain price quotes.

If the installation firm has been selected (if required), the user 14 can be presented with a commissioning page, where the user 14 can procure additional expert services. On this page, if necessary or desired, the user 14 can obtain additional expert input for the process or unit. The user 14 can select and contract with an expert at this step. The service provider can provide the additional expertise to the user 14, can procure the additional expertise for the user 14, or can provide access to various experts. The user 14 can select and contract with an expert at this step, or can just obtain price quotes.

Once the construction firm has been selected (if required), the user 14 is presented with an installation page, where the user 14 can procure installation cost quotes. These already may be included with the construction quotes, but also may be for additional necessary services such as piping. The user 14 can select and contract with an installation firm at this step. The service provider either can install the process or unit for the user 14, can procure the installation contractor for the user 14, or can provide access to various installation companies. The user 14 can select and contract with an installation contractor at this step, or can just obtain price quotes.

The user 14 then can be presented with an operation and maintenance page, where the user 14 can procure additional expert services for operating and maintaining the recently designed process. The user 14 can select and contract with an operation and maintenance firm at this step. The service provider either can provide the operation and maintenance services for the user 14, can procure the operation and maintenance contractor for the user 14, or can provide access to various operation and maintenance companies. The user 14 can select and contract with an operation and maintenance contractor at this step, or can just obtain price quotes.

In a preferred embodiment, the invention also can send automatic e-mails (or other means of correspondence or contact) to preferred suppliers and consultants and, whenever orders are placed with these suppliers and/or consultants, automatic e-mails (or other means of correspondence or contact) can be sent to the user 14 when the orders are fulfilled.

### Example 6-R&D, Inventions, and Process Innovations

This example is intended to illustrate that the present invention can be applied to fields that utilize formulas and rules.

Chemical and process manufacturing involves numerous mathematical algorithms, complex PDE/ODE models, significant R&D, extensive pilot testing and simulations, and a variety of process control systems and instrumentation. For example, they may test what-if scenarios or new products. The present invention can be configured to integrate and combine these elements in one unified arrangement for easy access and subsequent retrieval by individuals at a distance. The user 14 can add the information to the database and subsequently adjust the parameters to test the process or operation. After the neural network/expert system is configured to analyze the database and parameters, the method can provide modeling for the process or operations. If the modeled results are not optimal, the user 14 can adjust the parameters to achieve desired results. The user 14 can choose to save the results to the database for future manipulation.

The present invention can provide the user 14 with the opportunity for others in different locations to view and manipulate the perimeters. If the program is administered via a network, other users with access can adjust the parameters to produce and achieve more optimal results. Additionally, if a user 14 is removed from the project, the prior results and models will be the database for future modeling.

### Example 7-Additional Fee Model

Another preferred embodiment of the present invention includes a fee model for the generation of additional revenue from selected commissions and fees. One preferred embodiment of the invention provides for the ability to generate and track revenue from commissions and troubleshooting services. The user 14 can be charged a commission for on-line orders for equipment, civil construction, erection, installation, and commissioning services provided by preferred vendors. Likewise, the use of on-line quality assurance and quality control services and production troubleshooting tools can be charged to the user. Further, the use of on-line support services can be coupled with a commission from the experts and consultants for orders placed to them by the users. Preferably a fee per transaction is charged for all services provided through the invention.

The fee model allows the service provider to generate revenue, if the service provider installs a process or unit, constructs process or unit, provides the additional expertise and/or provides the operation and maintenance services. First, the service provider can provide services with an appropriate profit margin built into the price. Alternatively, if the service provider procures the construction contractor for the user, the service provider can include a service fee or a procurement fee. Alternatively, if the service provider allows third party construction companies to be contacted by the user through the invention, the service provider can collect a commission from the construction company and/or charge a subscription fee for allowing the construction company to be listed on the site.

As can be seen, the invention provides an automated online method for the design and implementation of engineering and manufacturing design services taking the user from the initial design stages all the way through to constructing and operating the design. The invention retains in memory all of the aspects of the design for later referral. Importantly, the invention retains the costs for the project and allows the user to track costs and the progress of the design. For example, all of the design, procurement, construction and operation of the project is tracked by the invention, allowing the user to have a one-stop location for a complete engineering solution. If costs change, or construction strays from a schedule, the user can choose, online, alternative vendors to put the project back on track.

The above detailed description of the preferred embodiments, examples, Appendix and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An artificial intelligence based automated system for capturing, synchronizing, and unifying engineering and manufacturing intelligence across an enterprise comprising:
a. identification of experts and expertise in an enterprise and its consultants;
b. receiving manufacturing intelligence information for the experts through a graphical interface;
c. allowing a user to process this information into a database for the artificial intelligence systems; and
d. making the manufacturing intelligence available for enterprise wide for instantaneous use.

2. The artificial intelligence based automated system as claimed in claim 1, wherein the artificial intelligence systems are selected from the group consisting of expert systems, neural networks, and data or predictions from a trainable neural network/expert system.

3. The artificial intelligence based automated system as claimed in claim 1, wherein the manufacturing intelligence is available for use in connection with the group consisting of design and engineering, research and development, process optimization, simulation and modeling purposes.

4. An automated system for engineering and manufacturing design comprising:
a. defining a knowledge base comprising information and rules;
b. receiving input parameters from a user through a graphical interface;
c. applying the knowledge base to the input parameters; and
d. arriving at a solution based on the application of the knowledge base to the input parameters.

5. An automated method for engineering and manufacturing design services as characterized in claim 4, wherein the user is to select a level of solution from a predetermined number of levels of solutions and the levels of solutions differ in service provided.

6. The automated method for engineering and manufacturing design services as characterized in claim 4, wherein the method is executed by a computer.

7. The automated method for engineering and manufacturing design services as characterized in claim 4, whereby the solution is stored as an analysis rule for future solutions.

8. The automated method for engineering and manufacturing design services as characterized in claim 7, wherein the solution is added to the knowledge base.

9. An automated system for engineering and manufacturing design comprising:
a. defining a knowledge base comprising information and rules;
b. receiving input parameters from a user through a graphical interface;
c. applying the knowledge base to the input parameters;
d. arriving at a solution based on the application of the knowledge base to the input parameters; and
e. storing the input parameters and the solution in the knowledge base as new information and rules.

10. An automated system for engineering and manufacturing design comprising:
a. defining a knowledge base comprising information and rules;
b. receiving input parameters from a user through a graphical interface;
c. applying the knowledge base to the input parameters;
d. arriving at a solution based on the application of the knowledge base to the input parameters;
e. storing the input parameters and the solution in the knowledge base as new information and new rules; and
f. using a neural network /expert system to process the knowledge base.

11. The automated system for engineering and manufacturing design as claimed in claim 10, wherein the neural network/expert system comprises:
a. analysis rules to allow the addition of questions and rules, algorithms, models on the fly;
b. the ability to reason probabilistically so as to enable probabilistic or best-fit recommendation capability so that the user can choose from multiple possibilities;
c. forward chaining including RETE implementation;
d. violation messages comprising rules that enforce cross-data validation;
e. why capabilities allowing the user to be able to query and understand why a recommendation by the system was made;
f. learning capabilities allowing an expert to interactively teach the system specific capabilities;
g. rule guessing allowing the system to be able to use rules with applicability levels so as to mimick the guessing of relationships;
h. self learning capabilities through probabilistic algorithms and numerical programming; and
i. data and rules clustering

12. An automated method for design engineering comprising:
a. creating a knowledge base that contains prior solutions and expert knowledge;
b. allowing a user to input parameters through a graphical interface;
c. applying the knowledge base to the input parameters using a neural network/expert system of analysis rules; and
d. generating a solution based on the knowledge base, the input parameters, and analysis rules,
wherein the solution can be included in the database.

13. The automated method for design engineering in claim 12, wherein the solution is added to the knowledge base for future application to input parameters.

14. A computer based system for design engineering and manufacturing design, comprising:
a. a computer based system for receiving and processing project parameters;
b. a knowledge base comprising information and rules;
c. a processing mechanism comprising a trainable neural network/expert system for processing the project parameters and knowledge base into a solution,
wherein the trainable neural network/expert system is trained by processing the solution and knowledge base, selecting project parameters associated with a specific project, and using analysis rules to discriminate between selected solutions from the knowledge base to arrive at the solution for the proper solution to the user's query and is trained from secondary inputs to the neural network/expert system that can further analyze original or transformed solutions.

15. The system claimed in claim 21, wherein the solution is stored in the knowledge base and the solution can be used for processing future project parameters.
